(19) United States
(12) Patent Application Publication
(10) Pub. No.: US 2006/0200811 A1
(43) Pub. Date: Sep. 7, 2006

(54) Method of generating optimised stack code

(76) Inventor: Stephen M.K. Cheng, Wellington (NZ)

Correspondence Address: NIXON & VANDERHYE, PC, 901 NORTH GLEBE ROAD, 11TH FLOOR, ARLINGTON, VA, 22203, US

(21) Appl. No.: 11/368,692

(22) Filed: Mar. 7, 2006

(30) Foreign Application Priority Data
Mar. 7, 2005 (NZ) 538643

(51) Int. Cl. G06F 9/45

(52) U.S. Cl. 717/144

(57) ABSTRACT

The present invention relates to a method for generating optimised stack code for a stack-based machine from a register-based representation of the original code. The method includes the steps of: creating a dependence graph from the representation; removing true dependencies from the dependence graph by matching portions of the dependence graph with a set of patterns; and defining stack code corresponding to the dependence graph using code generation rules associated with each pattern.

### FIELD OF INVENTION

The present invention relates to a method of generating optimised stack code. More particularly, but not exclusively, the present invention relates to generating optimised stack code for a stack-based machine from a register-based representation of the original code by converting the original code into a dependence graph and collapsing the dependence graph to remove true dependencies.

### BACKGROUND TO THE INVENTION

The stack model of execution uses a stack to hold temporary results during evaluation of a program. Implementations of the stack model, such as Java virtual machines for execution of stack-based Java bytecode, access the stack more efficiently than local variables. Thus, converting local variable accesses into stack accesses can improve the performance of stack-based programs.

A stack-based machine (a machine implementing the stack-based model of execution) is characterised by an instruction set including instructions popping one or more operands from the top of a stack and pushing the result (if any) onto the top of the same stack.

A stack-based machine typically has in addition a general storage area. An example of a general storage area is the variable slots in a Java virtual machine. A stack machine also typically supports one or more instructions that DO NOT pop operands from a stack or push any result into the same stack. A stack-based machine typically has one or more stack store instructions that transfer a value from the stack to the general storage area, and stack load instructions that transfer a value from the general storage area to the stack. A stack-based machine typically has one or more stack manipulation instructions whose function is to manipulate the values within the stack; such duplication of the top value of the stack, and swapping the top two values on the stack.

Performing program optimisation on a stack-based representation of a program is well known to be difficult as discussed in Intra-procedural Inference of Static Types for Java Bytecode, Etienne Gagnon and Laurie J. Hendren, March 1999 (http://www.sable.mcgill.ca/publications/techreports/#report1999-1):

“Optimising stack code directly is awkward for multiple reasons . . . First, the stack implicitly participates in every computation; there are effectively two types of variables, the implicit stack variables and explicit local variables. Second, the expressions are not explicit, and must be located on the stack. For example, a simple instruction such as AND can have its operands separated by an arbitrary number of stack instructions, and even by basic block boundaries.”

Research in optimisation in the past 20 years has concentrated on optimisation for register-based representations. Comparatively little research in optimisation had been done for stack-based representations. As a result the majority of optimising compilers and optimisers producing code for stack-based machines choose to use a register-based internal representation (IR) for its optimisation algorithms, and to then “translate” the register-based IR into stack-based code. Examples of compilers and optimisers using such a strategy include Soot (http://www.sable.mcgill.ca/soot/) and Flex (http://www.flex-compiler.lcs.mit.edu/).

There are well known methods to generate code for stack-based machines from a register based representation:
Bruno and Lassagne described a method in “The Generation of Optimal Code for Stack Machines” which walks the expression tree for a basic block in topological order and generates code for a stack-based machine. However this method does not work with a directed acyclic graph or directed graph. An expression directed acyclic graph or expression tree is required to be transformed into an expression tree first. Consequently common sub-expressions will have its code generated multiple times, or alternatively have their results stored into and loaded from a general storage area.
Peephole optimisations are traditionally employed to eliminate unnecessary stack load instructions and stack store instructions.
Koopman introduced a method called stack allocation to eliminate unnecessary stack store instructions and stack load instructions. However the stack allocation method does not reorder other instructions. As a result the quality of generated code depends on the underlying instruction scheduling method.

Compilers often use a representation called a dependence graph to represent constraints on code motion and instruction scheduling. The nodes in a dependence graph typically represent statements, and edges represent dependence constraints.

Compilers for languages supporting precise exceptions satisfy the precise exception requirement by imposing the following dependence constraints, described further in J.-D. Choi, D. Grove, M. Hind, and V. Sarkar, “Efficient and precise handling of exceptions for analysis of Java programs,” ACM SIGPLAN-SIGSOFT Workshop on Program Analysis for Software Tools and Engineering, September 1999:
1. Dependences among potentially excepting instructions (PEIs), referred to as exception-sequence dependences, which ensure that the correct exception is thrown by the code, and
2. Dependences between writes to non-temporary variables and PEIs, referred to as write-barrier dependences, which ensure that a write to a non-temporary variable is not moved before or after a PEI, in order to maintain the correct program state if an exception is thrown. These dependences hamper a wide range of program optimisations in the presence of PEIs, such as instruction scheduling, instruction selection (across a PEI), loop transformations, and parallelization. This impedes the performance of programs written in languages like Java, in which PEIs are quite common.

In addition, previous approaches to optimisation of instruction scheduling do not take account of the performance or size of the generated stack-code where common sub-expressions are involved.

Koopman's approach and its derivatives are only partial solutions, as they cannot fully overcome sub-optimal instruction sequences generated by an instruction scheduler that is not taking account of the cost and performance of the generated stack-code. To minimize stack store instructions, store load instructions, and stack manipulation instructions, it may be necessary to rearrange chucks of instructions. However by working only on the stack code, without a dependence graph, it is difficult to determine which code reordering is safe, consequently limiting the extent of optimisation.

On some platforms such as J2ME, there are tight constraints for the program size. It is therefore beneficial for a compiler and optimiser to generate size “optimal” code.

It is an object of the invention to provide a method of generating optimised stack-based code which overcomes the disadvantages of the prior art, or which at least provides a useful alternative.

### SUMMARY OF THE INVENTION

According to a first aspect of the invention there is provided a method for generating optimised stack code from a register-based representation, including the steps of:
i) creating a dependence graph from the representation;
ii) removing true dependencies from the dependence graph by matching portions of the dependence graph with a set of patterns; and
iii) defining stack code corresponding to the dependence graph using code generation rules associated with each pattern.

It is preferred that the representation is a representation of a basic code block or an extended basic code block.

Preferably, the dependence graph is a directed acyclic graph and is not a tree.

One or more of the patterns may not be a tree.

The code generation rules may include one or more rules from the set of inserting stack manipulation instructions, inserting stack store instructions, and inserting store load instructions.

It is preferred that the set of patterns includes a set of collapse patterns. It is further preferred that the set of patterns includes set of pass patterns.

Each collapse pattern may have a set of constraints. The set of constraints may include the dependency between nodes. The set of constraints may include the non-true dependency between nodes.

The step (ii) for removing true dependencies may include the sub-step of:
traversing the dependence graph and during the traversal of the graph applying the following rules:
a) if one or more nodes forming a portion of the graph match a pass pattern continue to-traverse the graph;
b) if two or more nodes forming a portion of the graph match a collapse pattern collapse the nodes to a single collapsed node; and
c) if one or more nodes forming a portion of the graph do not match either a pass pattern or a collapse pattern then define the result of a node to be stored.

It is preferred that the graph is traversed in reverse topological order.

Preferably, if rule (c) applies then the traversal of the graph is rolled-back to a position where the result of a node can be stored according to a predetermined rule. 13. The rolling-back may include un-collapsing one or more collapsed nodes.

It is preferred that a collapse pattern which creates a single collapsed node is associated with a code generation rule which leaves the result of the single collapsed node on the stack when one or more nodes in the graph have a true dependence on the single collapsed node.

It is also preferred that a collapse pattern which creates a single collapsed node with a true dependence on one or more result-generating nodes in the graph is associated with a code generation rule which removes the results of the one or more result-generating nodes from the stack.

Stack code may be defined in step (iii) by traversing the graph and during traversal applying the following rule:
if the node is a collapsed node then schedule the constituent nodes according to the code generation rules associated with the pattern that matched the collapsed node.

The stack code may be JAVA bytecode or ECMA-335 instructions.

According to a further aspect of the invention there is provided a system for generating optimised stack code from a register-based representation, including:
a processor arranged for creating a dependence graph from the representation; removing true dependencies from the dependence graph by matching portions of the dependence graph with a set of patterns; and
defining stack code corresponding to the dependence graph using code generation rules associated with each pattern.

According to a further aspect of the invention there is provided software arranged for performing the method or system of any one of the preceding aspects.

### BRIEF DESCRIPTION OF THE DRAWINGS

Embodiments of the invention will now be described, by way of example only, with reference to the accompanying drawings in which:

FIG. 1a: shows a flow diagram of the method of the invention

FIG. 1: shows an instruction set for a stack-based machine

FIG. 2: shows an instruction set for a register-based representation

FIG. 3: shows a basic block of code in a register-based representation

FIGS. 4a and 4b: show a set of collapse patterns

FIG. 5: shows a set of pass patterns

FIG. 6: shows a dependence graph for the basic block of code shown in FIG. 3

FIG. 7: shows the dependence graph after a first collapse pattern match

FIG. 8: shows the dependence graph after a second collapse pattern match

FIG. 9: shows the dependence graph after a third collapse pattern match

FIG. 10: shows the dependence graph after a fourth collapse pattern match

FIG. 11: shows the dependence graph after a fifth collapse pattern match

FIG. 12: shows the dependence graph after a sixth collapse pattern match

FIG. 13: shows the dependence graph after storing a first child node

FIG. 14: shows the dependence graph after a subsequent pattern match

FIG. 15: shows the dependence graph after storing a second child node

FIG. 16: shows the dependence graph after a subsequent pattern match

FIG. 17: shows the dependence graph with all true dependencies removed

FIG. 18: shows the generation of optimised stack-based code for a node in the dependence graph following the code generation rules

FIG. 19: shows a version of optimised stack-based code for the basic block of code shown in FIG. 3

### DETAILED DESCRIPTION OF PREFERRED EMBODIMENTS

The present invention will be described in relation to a method of generating optimised stack code for a stack-based machine from a register-based representation of the code.

It will be appreciated that the method may be implemented within optimisers or compilers.

The advantage of the method of the present invention is the production of compact and efficient code for stack based machines from a register based representation.

The method will decide for each expression whether the result of that expression is required to be stored in the general store area, and what stack manipulation instructions, stack store instructions and stack load instructions are required to be inserted.

The method of the invention makes efficient use of the characteristics of a stack-based machine and the particular set of stack manipulation instructions available on a particular stack-based machine, by generating code with “minimal” number of stack store instructions, stack load instruction, and stack manipulation instructions. Minimal, in this case, can mean minimal (though not necessarily optimal) in terms of performance, or of size, or a balance of both, depending on the particular design and implementation goals and contexts of the optimisation algorithm and the choice of patterns for the set of patterns used within the method.

A reference to a variable is said to be live at a program point if the value of the variable is used after that program point on some control flow path to the exit before it is redefined.

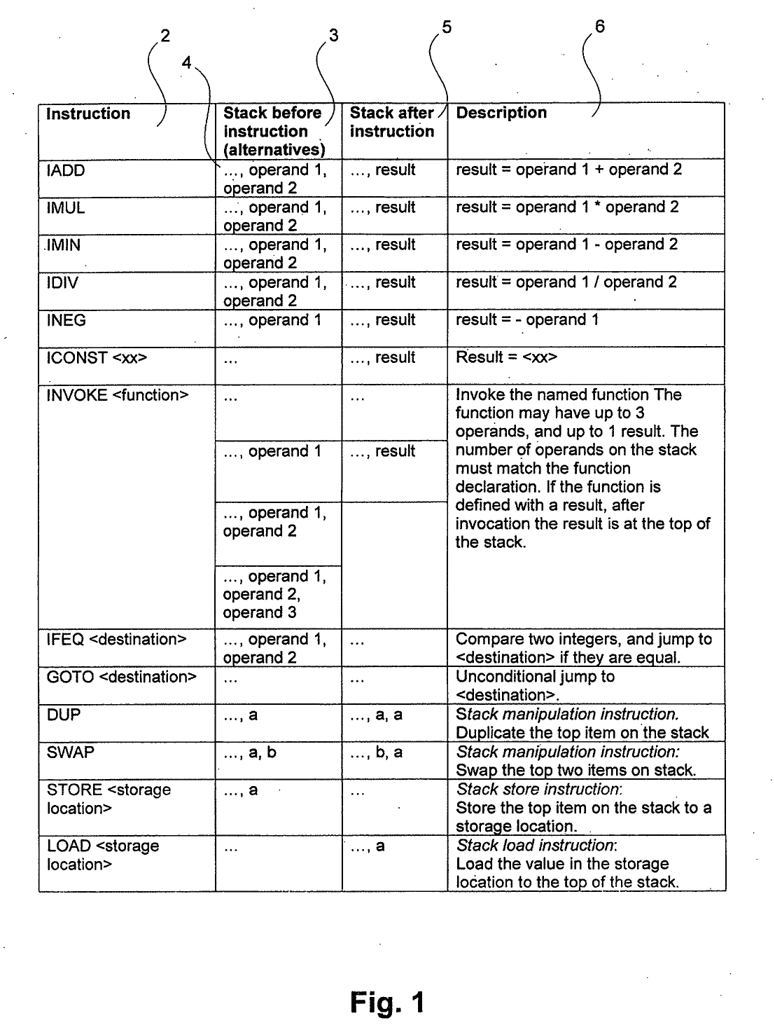

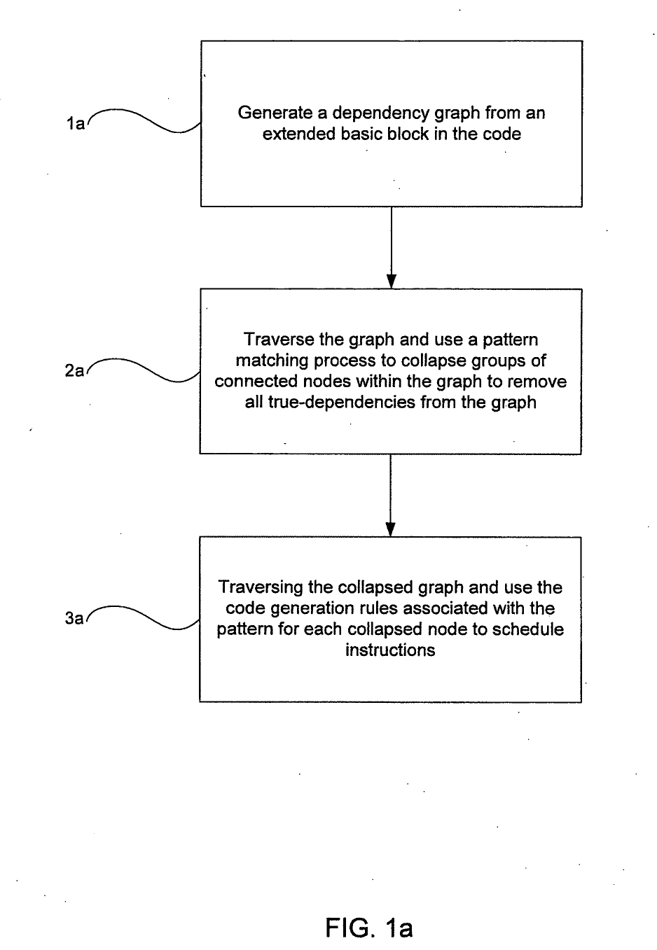

Referring to FIG. 1a, a preferred embodiment of the method of the invention will be described.

In step 1a, a directed acyclic dependence graph is created from the register-based representation that is to be optimised. In a preferred embodiment the code is split into basic blocks and the optimisation method is performed on each basic block. It will be appreciated that the current innovation can be easily extended to work on extended basic blocks and single-entry-single-exit regions.

A live variable analysis is performed to determine what result variables are live on the exit(s) of the basic block. These live-out result variables are defined to be stored within the general store area. If an expression takes one of these live-out result variables as an operand, the corresponding dependence graph would be constructed to refer to a “new” node representing the stored result of the variable, instead of the node which provides the result. Furthermore, a non-true dependency is added to indicate the dependence of the new node on the node which provides the result.

A live variable analysis is performed to determine what input variables are live on entry of the basic block. These live-in input variables are assumed to be stored within the general store area by the predecessor basic blocks. If an expression takes one of the abovementioned input variables as an operand, the corresponding dependence graph would be constructed to refer to a “new” node representing the stored result of the variable, instead of the node which provides the result.

The dependence graph is comprised of nodes which represent expressions. For each expression where the result of that expression is used by a subsequent expression, the node for that subsequent expression has a direct true dependence on the node for the result-generating expression. A direct true dependence is represented within the graph by a directed edge from the “subsequent” node to the “result-generating” node. There may other directed edges between nodes within the graph representing other constraints such as control dependencies or data dependencies other than true dependencies.

To speed up the computation process, if there exists a direct or transitive true dependency from Node A to Node B, and there exists a direct non-true dependency from Node A to Node B, the non-true dependency can be discarded from the dependence graph. Furthermore, if there exists a transitive non-true dependency from Node A to Node B through one or more other nodes, and there exists a direct non-true dependency from Node A to Node B, the direct non-true dependency can be discarded from the dependence graph.

In step 2a, the graph is traversed and a pattern matching process is applied to the nodes of the graph. The graph is preferably traversed in reverse topological order. However, it will be appreciated that other methods of traversal may be used.

During the traversal each node is checked to see whether it matches a pass pattern or a collapse pattern from a defined set of pass patterns and a defined set of collapse patterns.

The set of collapse patterns and pass patterns used in an implementation depends on the instruction set available, and the goal of the implementation (i.e. whether size optimisation or performance optimisation are preferred).

Each collapse pattern is associated with a code generation rule and may include a set of constraints that determine whether the collapse pattern could apply. The constraints may include non-true-dependency between nodes in the collapse pattern.

Generally to allow nesting of collapse patterns, no more than one of the constituent nodes in any collapse pattern may leave a value on the stack. However it is possible to construct a derivative of this method which includes collapse patterns generating more than one value on the stack.

The collapse patterns and the corresponding code generation rules are generally designed such that:
If any other nodes have a true dependency on the collapsed node, the corresponding code generation rule will leave the result of the expression represented by the collapsed node on the stack.
If the collapsed node has a true dependency on another node, the corresponding code generation rule will expect the result of the other node to be on the stack.

If the node matches a pass pattern that node is passed on. If the node matches a collapse pattern, the nodes that comprised the pattern are reduced to a single node within the graph.

It will be appreciated that if the node matches a collapse pattern, the nodes that comprise the pattern may be reduced to more than one node.

If the node does not match either a pass pattern or a collapse pattern and there are still true dependencies within the graph, the graph needs to be “broken” to store the result of a node within the general store area. The general store area is a direct memory access area rather than the stack from which data can only be used if it is on the top of the stack.

A preferred embodiment of the invention utilises a roll-back mechanism to increase the quality of generated stack code. This is beneficial if there exist circumstances where none of the pass patterns and collapse patterns match the node. For example, if a node does not match and there is a rule is to store the first operand used by that node, then the roll-back mechanism must undo all collapsing which occurred before the collapsing of the node which provides the non-matching node with the first operand.

If the graph has been rolled-back, the node which provides the result that is stored is defined to store the result of the node within the general store area and for all the nodes which have a true dependence on the resulting providing node a new node is created which represents the stored result and is defined to load the stored result from the general store area. All the nodes which have a true dependence on the result-providing node are changed to have a true dependence on their corresponding new node. Furthermore, a non-true dependency is added to indicate the dependence of the new node on the node which provides the result.

Optimised code is then generated in step 3a from the graph by traversing the graph and applying the code generation rules of each node. The graph is traversed in reverse topological order.

For each collapsed node, the associated code generation rules are used to specify the order in which the constituent nodes are to be processed. Where the constituent nodes are collapsed nodes the code generation rules for this node will be used to schedule order within that node. It will be understood that within the graph there is likely to be many collapsed nodes nested within one another.

Where the node is a stored result node, the code that is generated is a stack load instruction, to load the result from the general store area.

In addition, where the node has been defined to store its result, the code that is generated includes a stack store instruction to store the result within the general store area.

The following is an example of the generation of optimised code for a stack-based machine from code for a register-based representation.

FIG. 1 illustrates the instruction set of an example stack-based machine for which optimised code is to be generated. The first column 2 shows each instruction in the instruction set. The second column 3 shows the operands which must be present at the top of the stack before the instruction can be executed. In this figure, the contents of the stack are illustrated from right to left such that the rightmost operand is at the top of the stack. For example, the stack contents 4 before an IADD instruction must comprise ‘operand 2’ at the top of the stack and ‘operand 1’ second in the stack. The third column 5 shows the contents of the stack after the instruction has been executed. The fourth column 6 provides a description of the instruction named in the first column 2.

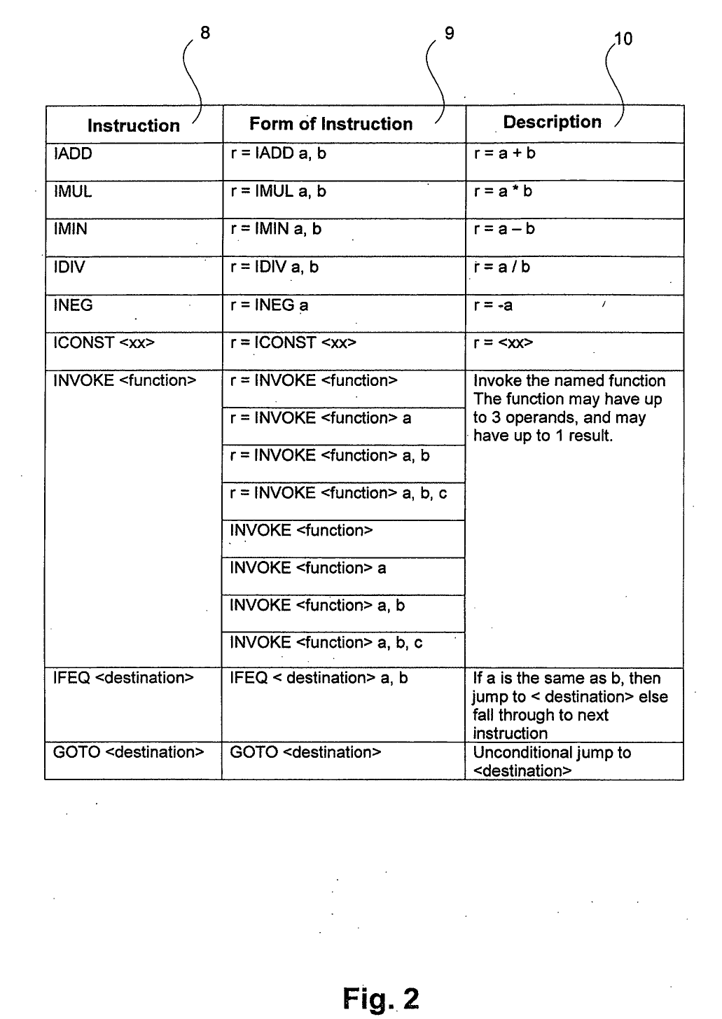

FIG. 2 illustrates the instruction set of the corresponding register-based representation. As in FIG. 1, the figure shows the instruction 8, the form of the instruction when the code in register-based representation has been generated 9 and a description of the instruction 10. In the example shown the stack-based machine and the register-based representation are nearly identical; the order of operands expected by each pair of corresponding instructions are identical and the instruction sets are identical disregarding the stack manipulation instructions, stack load instructions and stack store instructions. However it will be appreciated that for practical purposes, the instruction set of register-based representation may not directly map to the instruction set of the stack-based machine; in which case a modification of the current method could be produced to take account of the non-perfect mappings.

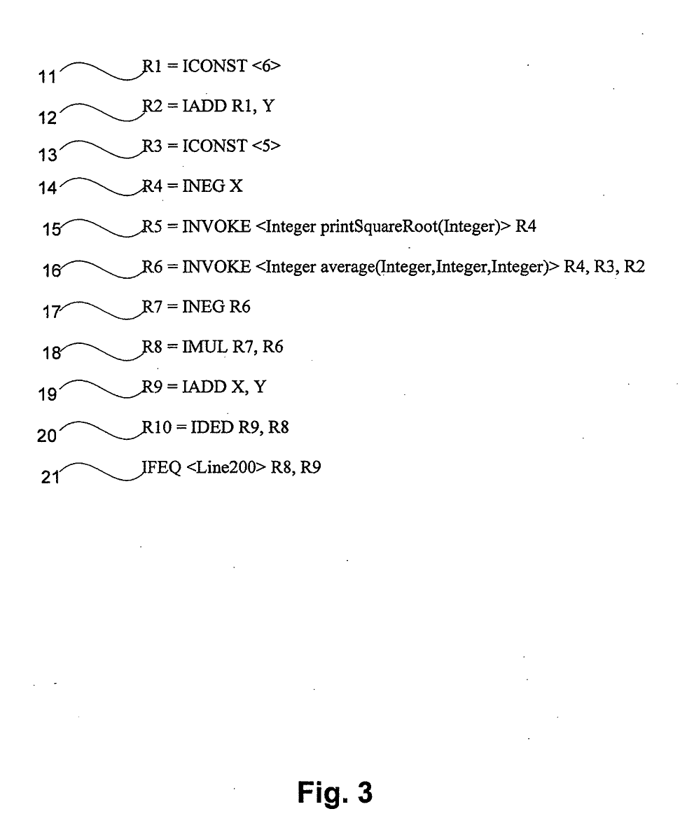

FIG. 3 is an example of a basic block of code generated for a register-based representation. Within this block of code it is to be noted that the IFEQ instruction 21 has a control dependency on the INVOKE <Integer average(Integer, Integer, Integer)> instruction 16. Also, the INVOKE <Integer average(Integer, Integer, Integer)> instruction 16 has a control dependency on the INVOKE <Integer printSquareRoot(Integer)> instruction 15. Also, the IFEQ instruction 21 has a control dependency on the IADD instruction 12. The variables X and Y as used in lines 12, 14 and 19 are defined in a predecessor code block, thus they are live-in variables with respect to the code block shown. R10, 20, is a live-out variable, thus it is live when the basic block exits. In this example it is assumed that the other intermediate variables are not live-out variables.

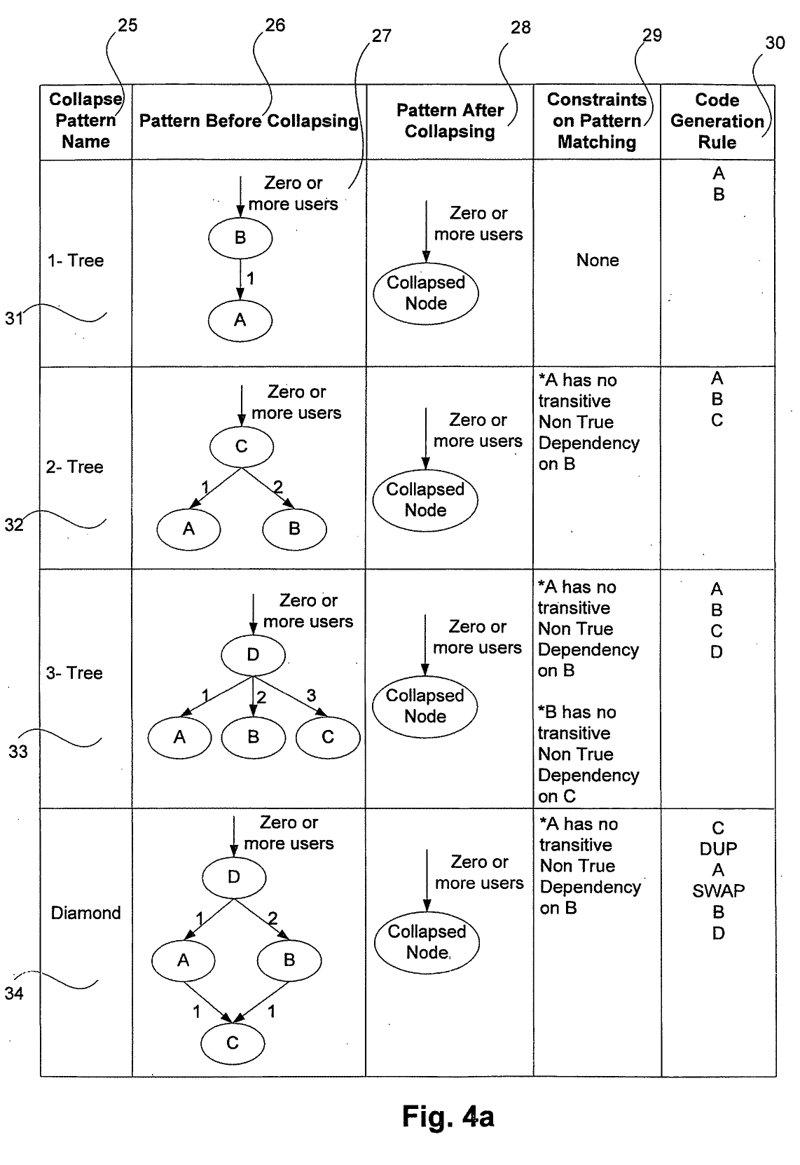

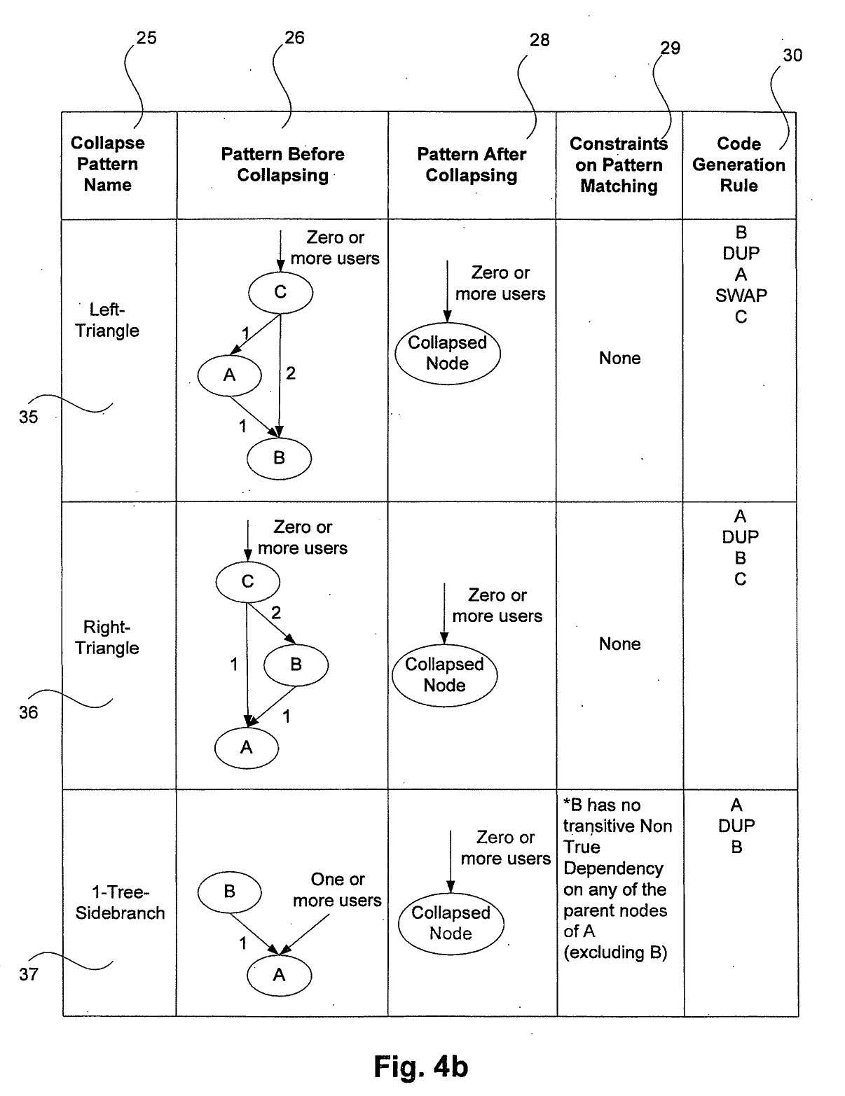

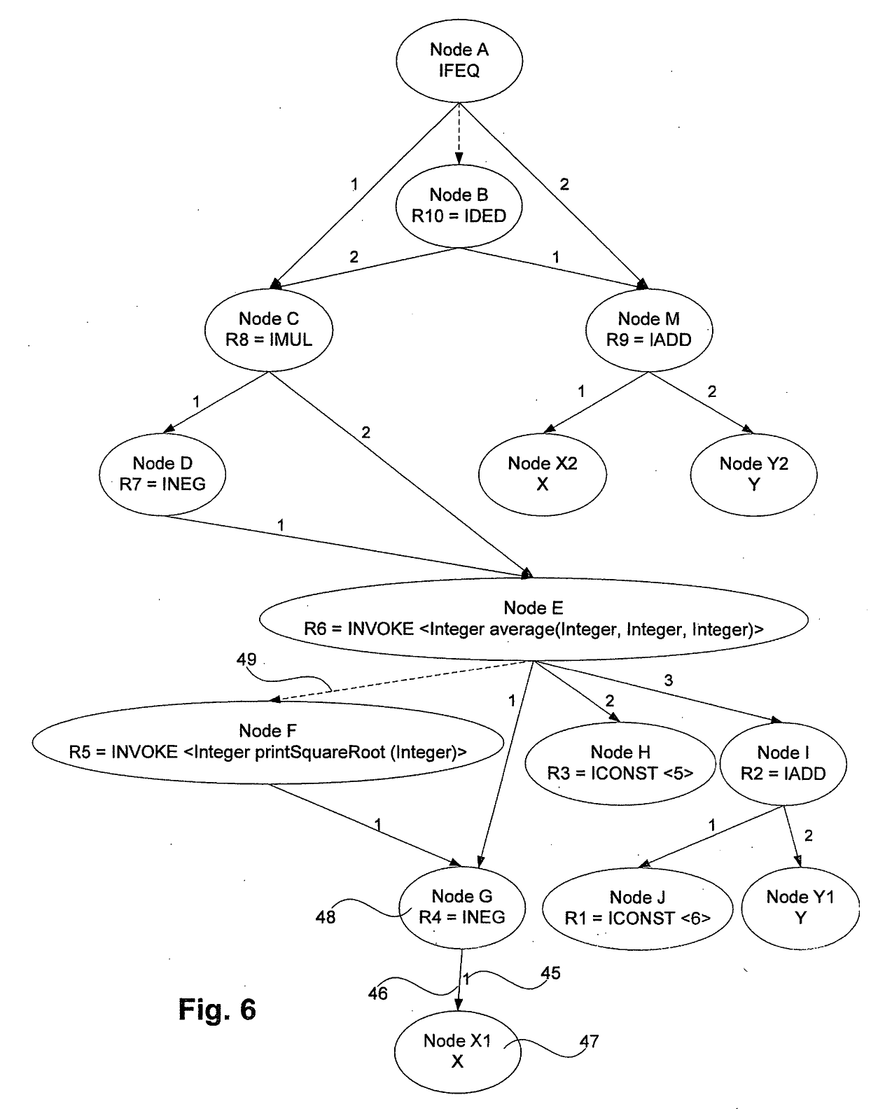

The dependence graph corresponding with the basic block of code in FIG. 3 is shown in FIG. 6. The method of the invention involves the removal of all true dependencies from the dependence graph. This is achieved through traversal of the graph and matching portions of the graph to collapse patterns. The collapse patterns to which portions of the graph may be matched are shown in FIGS. 4a and 4b. For ease of description, each collapse pattern has a descriptive name 25. The collapse pattern which may be matched is shown at 26. The first collapse pattern 27 shows that this collapse pattern will match a portion of the dependence graph where there is a node B which is the child of zero or more nodes (not shown), and has one child, node A. The number “1” on the edge between node B and node A shows that node A is the first operand for node B. FIGS. 4a and 4b also show the pattern 28 into which the matched collapse pattern 26 collapses. Any constraints 29 on the matching of the collapse pattern 27 are described. A common constraint is the requirement of an absence of any transitive non true dependency between two nodes. A first node may be said to have a transitive non true dependency on a second node if the first node has a direct non true dependency on the second node or the first node has a direct non true dependency on a third node and the third node has a transitive non true dependency on the second node. In the final column in FIGS. 4a and 4b is shown the code generation rule 30 for the matched collapse pattern. The code generation rule 30 produces the optimal code for the portion of the dependence graph which matches the collapse pattern 27.

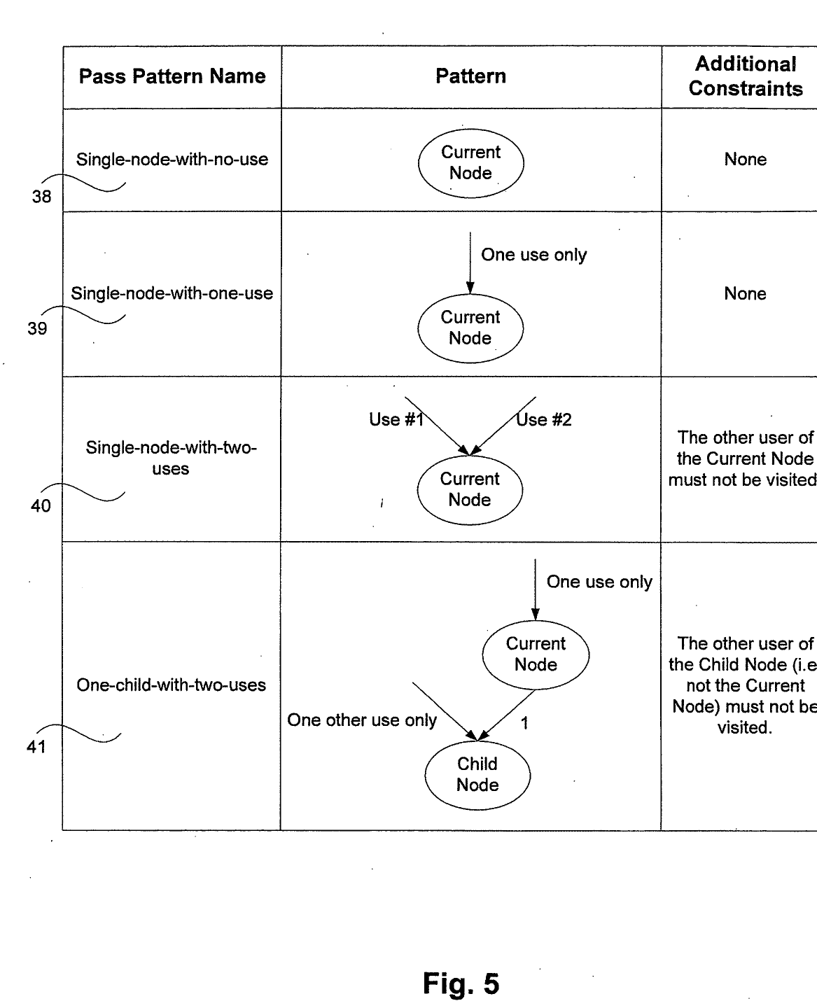

The method of the invention also uses pass patterns in the traversal of the dependence graph. An example set of pass patterns are shown in FIG. 5. As with FIGS. 4a and 4b, FIG. 5 shows the name of the pass pattern, the pass pattern which may be matched to a portion of the dependence graph and any constraints on the matching of the pass pattern.

The graph shown in FIG. 6 is traversed starting at Node X1 47. In a preferred embodiment of the invention, the dependence graph is traversed in reverse topological order. This traversal order ensures that a child node is always visited before a parent node. Therefore, it can be assumed that the child nodes have been collapsed by pattern matching as much as possible before the parent node is examined. This results in fewer and simpler patterns being required to optimise the code.

In the dependence graph of FIG. 6, the numbers 45 on the edges 46 of the graph indicate the operand number of the parent node. For example the number “1” on the edge 46 indicates that the result of Node X1 47 is the first operand of the parent node, Node G 48. True dependencies are shown by solid line edges of the graph 46. Non true dependencies are shown by dashed line edges of the graph 49. The graph is traversed in order of true dependency edges, followed by non true dependency edges. Furthermore, true dependency edges are traversed in order of their operand number 45.

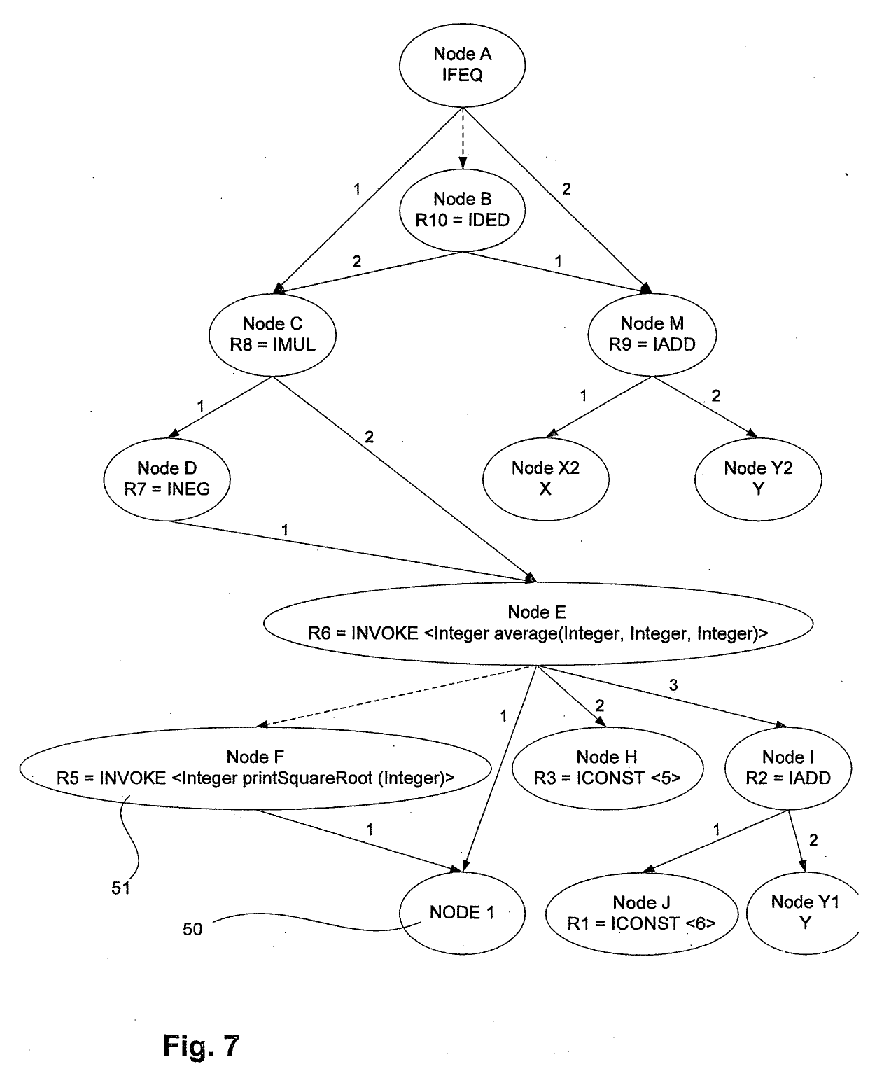

Node X1 47 is the first node visited in the traversal of the dependence graph. As this is a simple node it does not match any of the collapse patterns. However, it does match the pass pattern node-with-one-use 39 shown in FIG. 5. Therefore, we pass this node and move to the next node, Node G 48. This node 48 matches a 1-tree pattern 31 shown in FIG. 4a. Therefore nodes 47 and 48 are collapsed and a collapsed node, Node 1 is produced 50 as shown in FIG. 7.

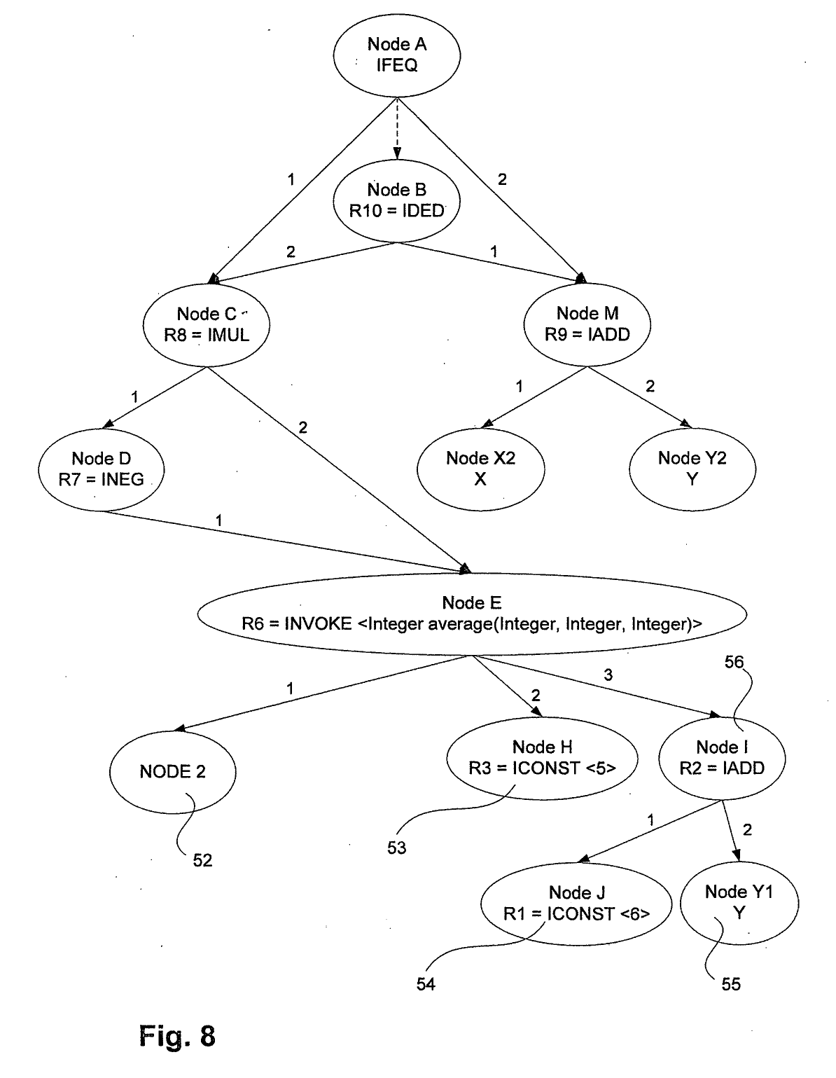

The next node to be considered is the collapsed Node 1 50. This node matches 1-tree-sidebranch pattern 37. Therefore a collapsed node can be created comprising Node F 51 and Node 1 50. The collapsed node 52 is shown in FIG. 8.

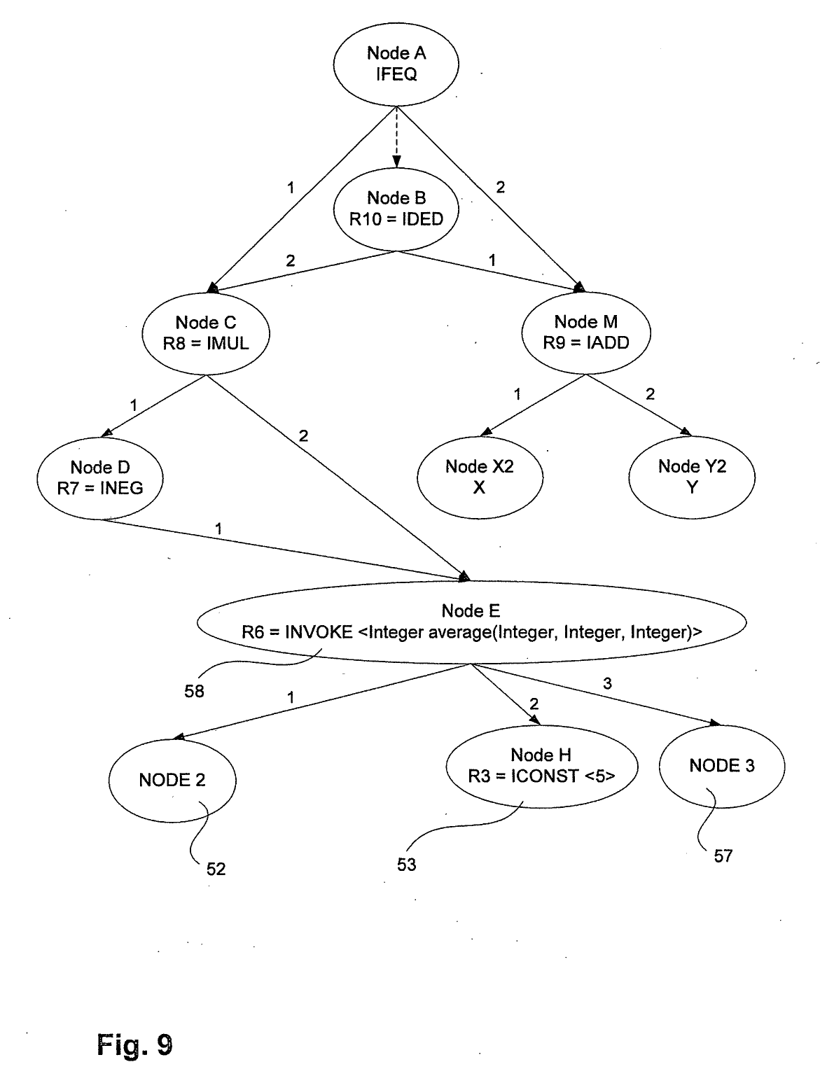

Node 2 52 matches pass pattern single-node-with-one-use 39. Therefore, this node is passed and the next node to be considered is Node H 53. Node H 53 does not match a collapse pattern, but does match pass pattern single-node-with-one-use 39. Therefore, the traversal moves to the next node, Node J 54. This node, and the subsequent node to be considered, Node Y1, 55, each do not match a collapse pattern, and match pass pattern single-node-with-one-use 39. Therefore, these two nodes are passed, and the traversal moves to Node I 56. This node 56 matches a 2-tree pattern 32 shown in FIG. 4a. Therefore Node J 54, Node Y1 55 and Node I 56 are collapsed to create collapsed node Node 3 57 shown in FIG. 9.

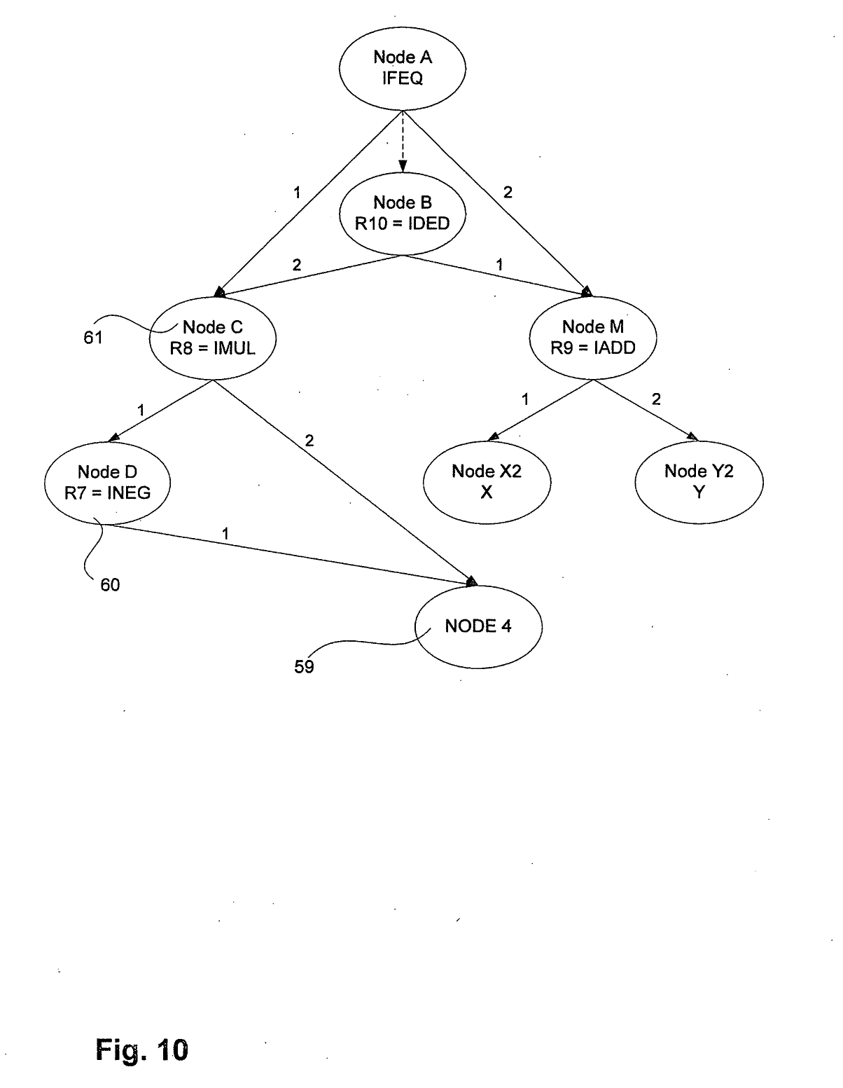

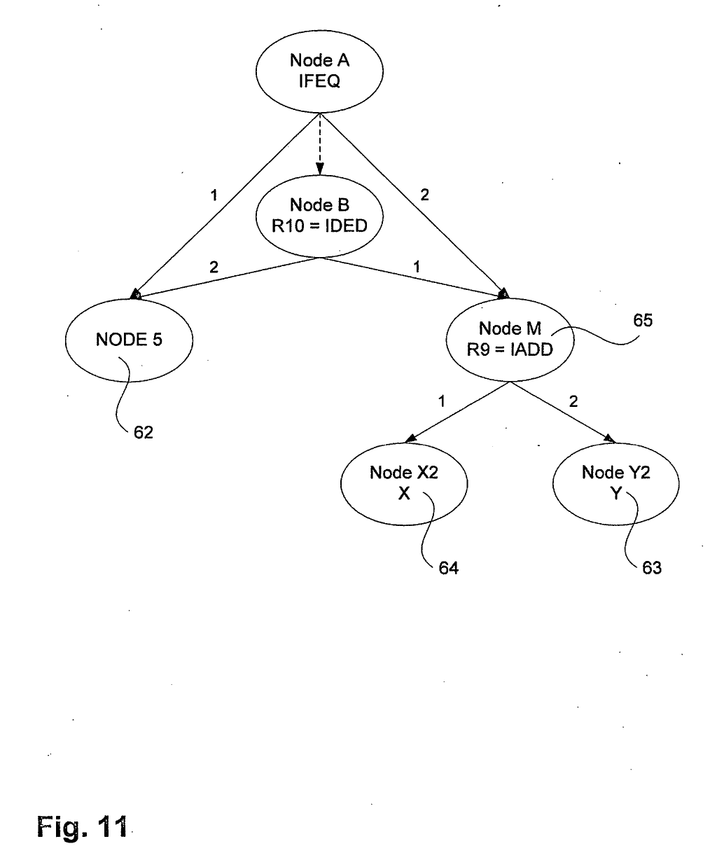

Node 3 57 matches the pass pattern single-node-with-one-use 39, therefore, traversal moves to Node E 58. This node matches a 3-tree pattern 33 shown in FIG. 4a, comprising Node 2 52, Node H 53, Node 3 57 and Node E 58. These nodes are collapsed into collapsed node Node 4 59 shown in FIG. 10. Node 4 59 matches pass pattern single-node-with-two-uses 40, therefore, traversal moves to Node D 60. This node 60 does not match any collapse patterns, however, it does match pass pattern one-child-with-two-uses 41. Therefore, the node is passed and Node C 61 is considered. This node matches the left-triangle 35 collapse pattern shown in FIG. 4b. Therefore Node 4 59, Node D 60 and Node C 61 are collapsed into collapsed node Node 5 62 as shown in FIG. 11.

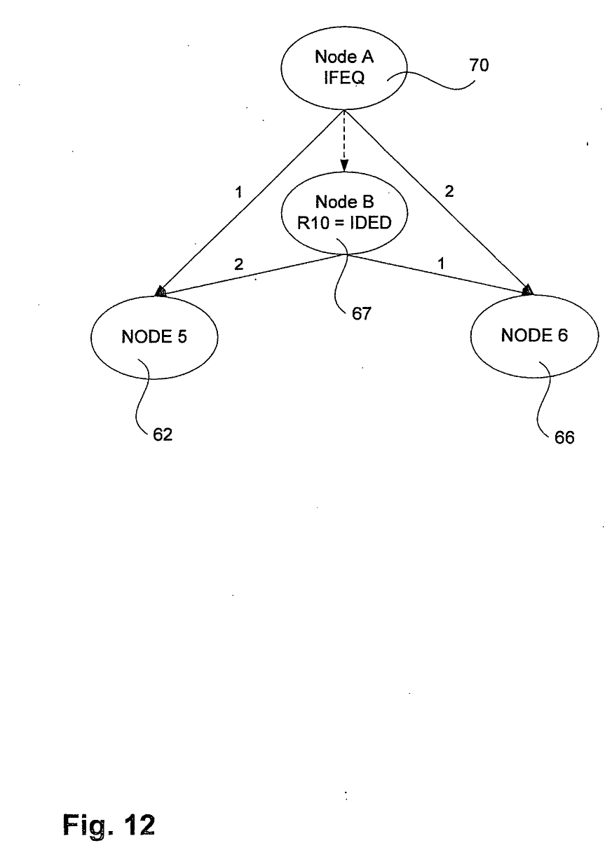

Node 5 62 matches the pass pattern single-node-with-two-uses 40, therefore, traversal moves to Node X2 64. Neither this node 64, nor the following node to be considered Node Y2 63, match any collapse patterns, and each of these nodes 63, 64 match pass pattern single-node-with-one-use 39. Therefore, both nodes 63 and 64 are passed and traversal moves to Node M 65. Node M 65 matches collapse pattern 2-tree 32. Collapsed node Node 6 66 is created comprising Node Y2 63, Node X2 64 and Node M 65. Node 6 66 is shown in FIG. 12.

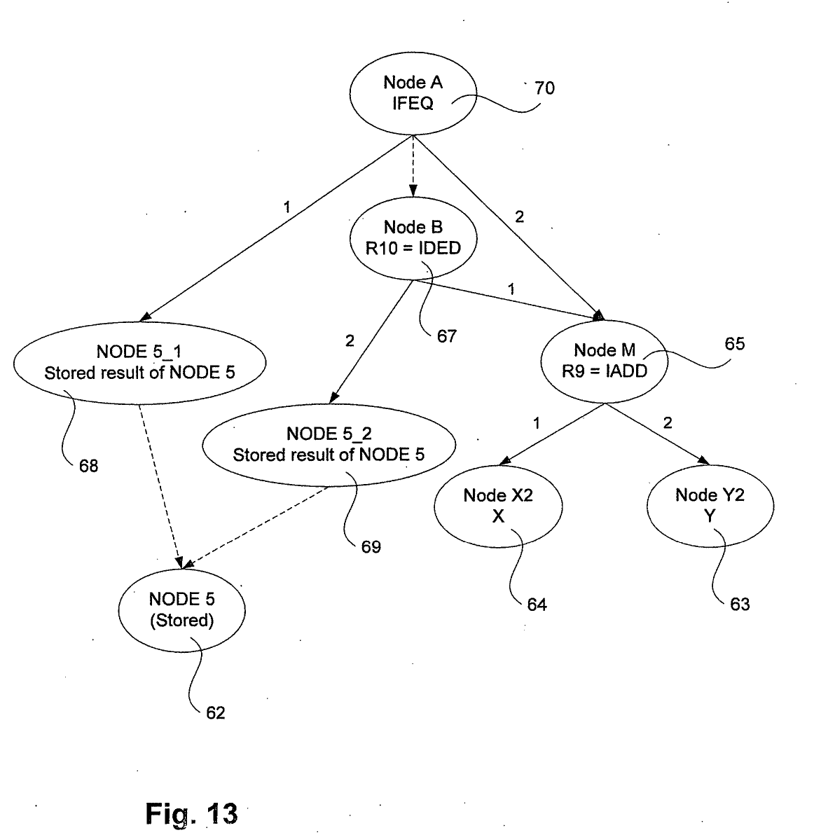

Node 6 66 matches the pass pattern single-node-with-two-uses 40, therefore, traversal moves to Node B 67. Node B 67 does not match any collapse patterns, and does not match any pass patterns. Therefore, the graph needs to be ‘broken’ by storing the result of one of the nodes. In a preferred embodiment, the result of the first child node of Node B 67 is stored. Node 5 62 is the first child node, therefore, the result of this node must be stored. Before the result of the node 62 is stored, all collapsing of the dependence graph that occurred after the creation of Node 5 62 must be undone. The creation of Node 6 66 must be undone and Node Y2 63, Node X2 64 and Node M 65 restored. The result of Node 5 62 may then be stored and those nodes 67, 70 that were dependent on Node 5 62 must be made dependent on the stored result 68, 69 of Node 5 62. This is shown in FIG. 13.

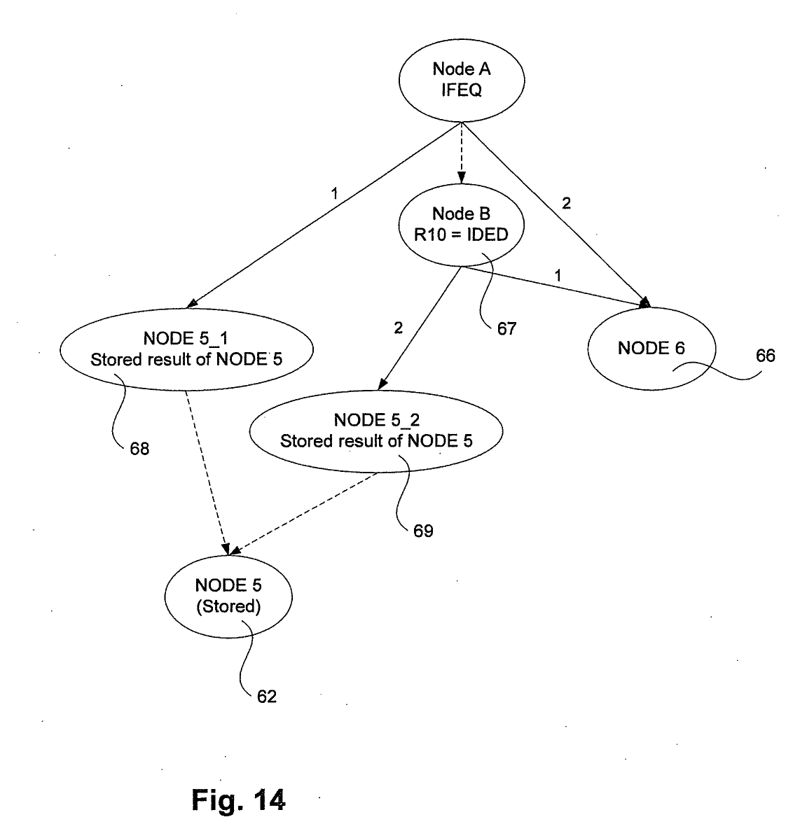

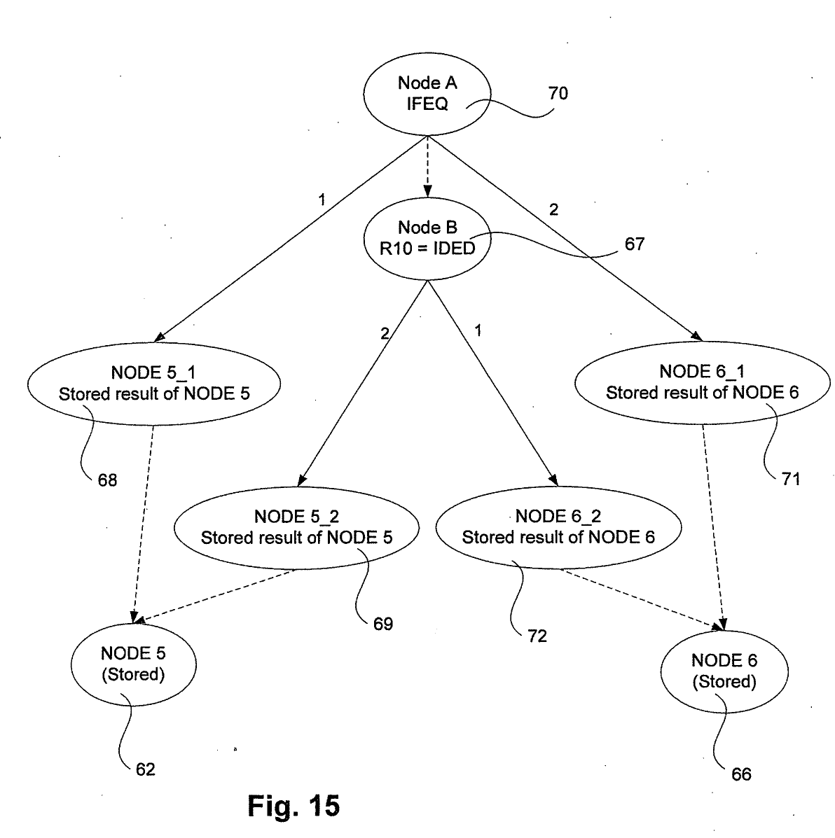

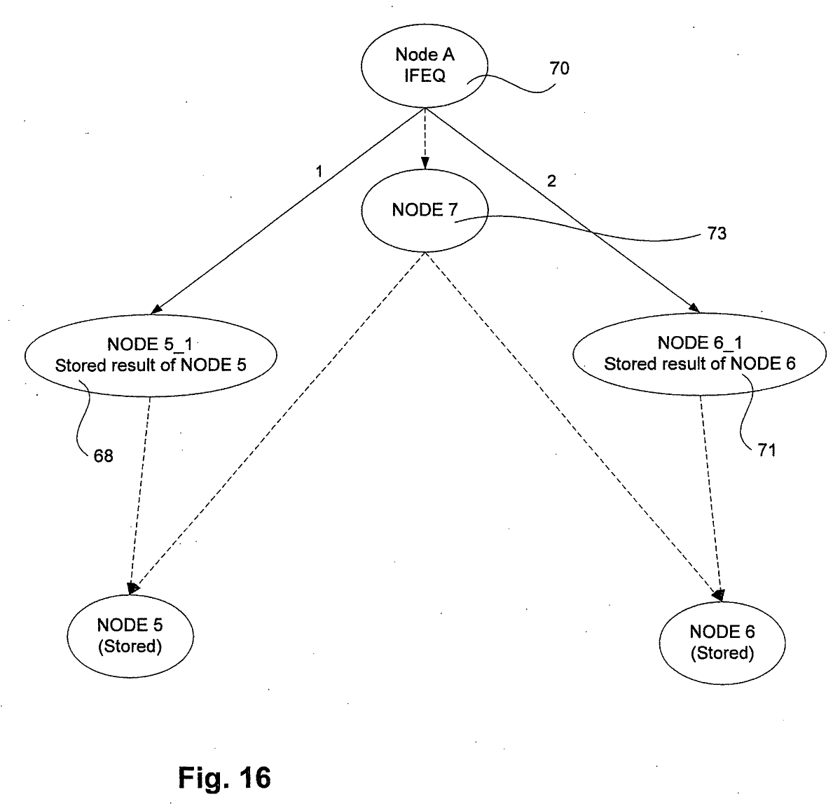

After storing Node 5 62, the traversal of the graph continues to Node X2 64. In FIG. 14, in the same way as described above, Node X2 64 and Node Y2 63 match pass patterns and Node M 65 matches a collapse pattern and Node 6 66 is created. Once again Node 6 66 is considered and found to match the pass pattern single-node-with-two-uses 40. Node B 67 is now reconsidered. Once again Node B 67 does not match any collapse patterns or any pass patterns. The first child of Node B 67 has been stored, therefore, the second child Node 6 66 must be stored. After storage of Node 6 66, the dependence graph is as shown in FIG. 15. Node B 67 and Node A 70 which were dependent on Node 6 66 are now dependent on the stored result 71, 72 of Node 6 66. Node B 67 is considered for a third time. After storing the results of Node 5 62 and Node 6 66, Node B 67 is found to match the collapse pattern 2-tree 32. As shown in FIG. 16, Node B 67, the stored result of Node 5 69 and the stored result of Node 6 72 are collapsed into collapse Node 7 73.

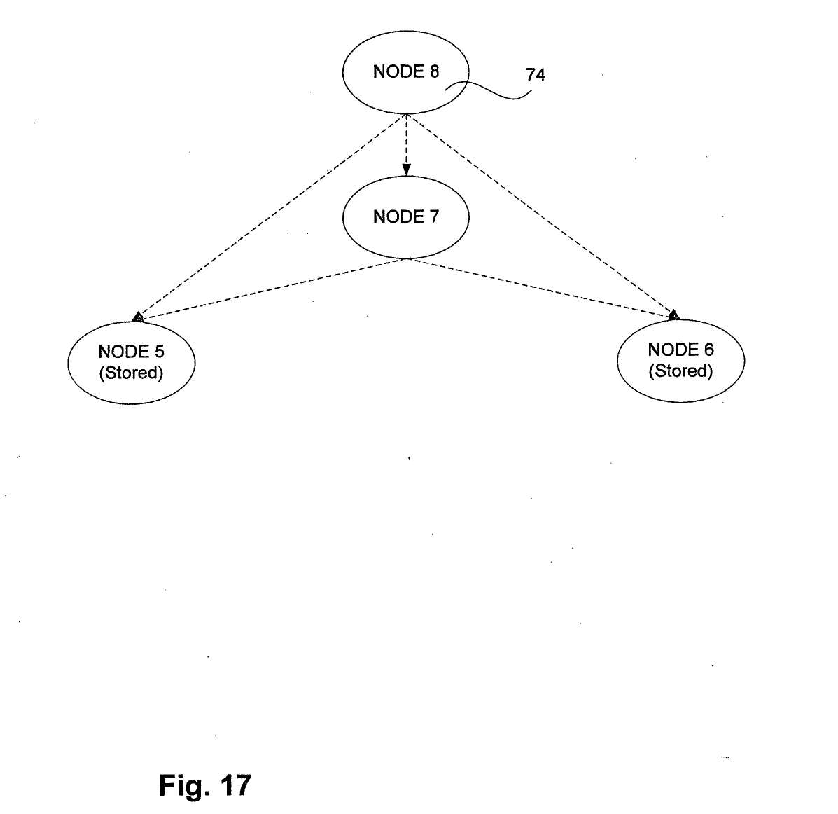

Continuing with the traversal of the graph, Node A 70 is the next node to be considered. Node A 70 matches the collapse pattern 2-tree 32. Therefore, as shown in FIG. 17, collapse Node 8 74 can be created from Node A 70, the stored result of Node 5 68 and the stored result of Node 6 71.

FIG. 17 shows a dependence graph in which the edges show only non true dependencies, therefore, pattern matching is complete. In order to generate optimised code for the stack-based machine it is necessary to sequentially deconstruct the nodes of the collapsed graph and apply the code generation rules for each collapsed node. In a preferred embodiment, the collapsed graph is traversed in reverse topological order. This order may be Node 5, Node 6, Node 7, Node 8 or Node 6, Node 5, Node 7, Node 8. The code generation rules are applied to the nested components of each collapsed node.

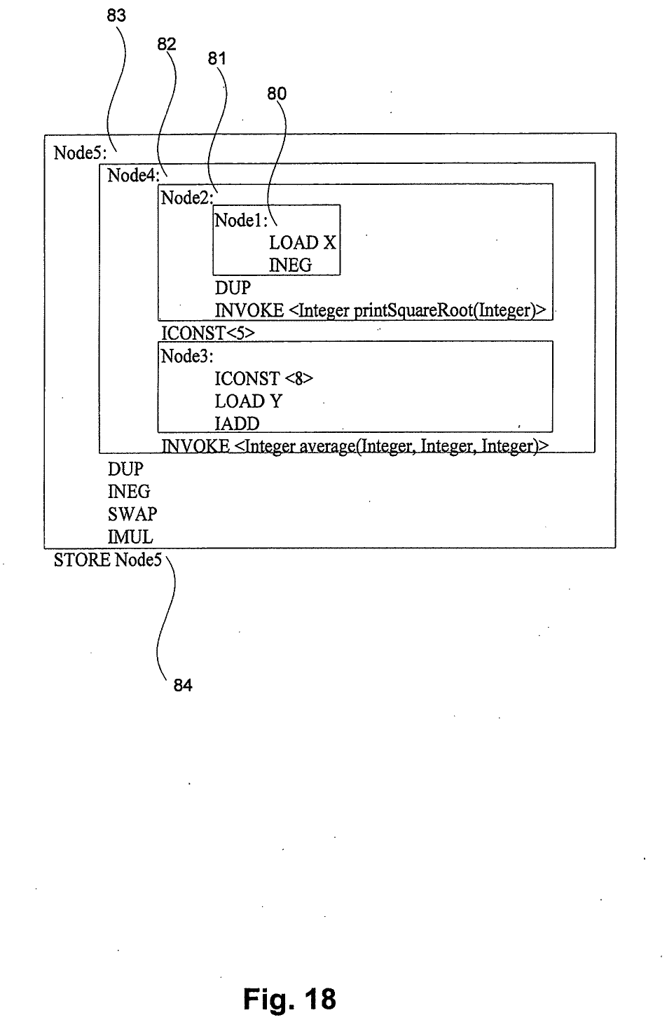

Node 5 contains Node 4, which in turn contains Node 3 and Node 2, which in turn contains Node 1. FIG. 18 shows the code generated following the code generation rules for Node 5. The code generation rule for the pattern which resulted in each collapsed node is followed. For example, box 80 contains the code corresponding to Node 1; box 81 contains the code corresponding to Node 2 which includes the code corresponding to Node 1 and two additional instructions. The code corresponding to Node 4 82 contains the code corresponding to Nodes 2 and 3 and 2 additional instructions. The code corresponding to Node 5 83 does not include the store instruction 84. This store instruction does not form part of the code generation rules, but is inserted when, following the method of the invention, it is found that it is necessary to store the result of a node. Correspondingly, a load instruction will be inserted into the code for a node which uses the stored result of a node.

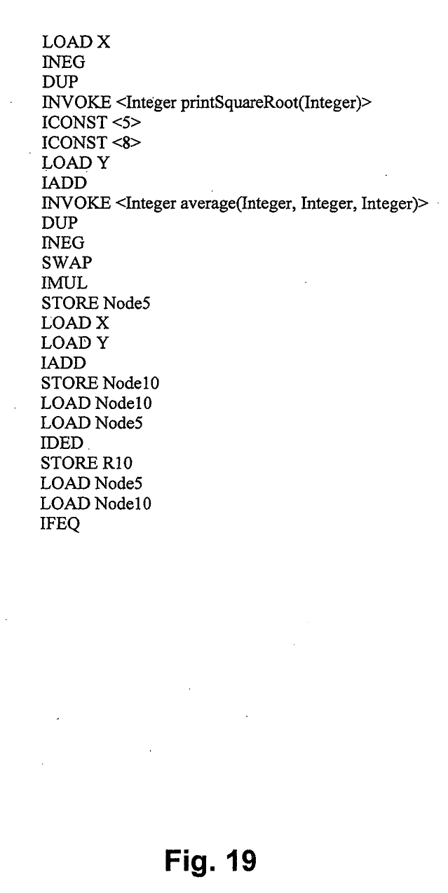

FIG. 19 shows the optimised code which may be generated for a stack-based machine from code in register-based representation following the method of the invention.

The advantages of the present invention include the following:
Provision of a method to schedule instructions for a stack-based machine taking into account the characteristics of the stack-based machine.
Does not preclude the use of peephole optimisation to clean up the code afterwards.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for generating optimised stack code from a register-based representation, including the steps of:
i) creating a dependence graph from the representation;
ii) removing true dependencies from the dependence graph by matching portions of the dependence graph with a set of patterns; and
iii) defining stack code corresponding to the dependence graph using code generation rules associated with each patter.

2. A method as claimed in claim 1, wherein the representation is a representation of a basic code block or an extended basic code block.

3. A method as claimed in claim 2, wherein the dependence graph is a directed acyclic graph and is not a tree.

4. A method as claimed in claim 3, wherein one or more of the patterns is not a tree.

5. A method as claimed in claim 1, wherein the code generation rules include one or more rules from the set of inserting stack manipulation instructions, inserting stack store instructions, and inserting store load instructions.

6. A method as claimed in claim 5, wherein the set of patterns includes a set of pass patterns and a set of collapse patterns.

7. A method as claimed in claim 6, wherein step (ii) includes the sub-step of:
traversing the dependence graph and during the traversal of the graph applying the following rules:
a) if one or more nodes forming a portion of the graph match a pass pattern continue to traverse the graph;
b) if two or more nodes forming a portion of the graph match a collapse pattern collapse the nodes to a single collapsed node; and
c) if one or more nodes forming a portion of the graph do not match either a pass pattern or a collapse pattern then define the result of a node to be stored.

8. A method as claimed in claim 7, wherein the graph is traversed in reverse topological order.

9. A method as claimed in claim 8, wherein each collapse pattern has a set of constraints.

10. A method as claimed in claim 9, wherein the set of constraints include the dependency between nodes.

11. A method as claimed in claim 10, wherein the set of constraints include the non-true dependency between nodes.

12. A method as claimed in claim 7, wherein if rule (c) applies then the traversal of the graph is rolled-back to a position where the result of a node can be stored according to a predetermined rule.

13. A method as claimed in claim 12, wherein the rolling-back includes un-collapsing one or more collapsed nodes.

14. A method as claimed in claim 1, wherein the set of patterns includes a set of collapse patterns and wherein a collapse pattern which creates a single collapsed node is associated with a code generation rule which leaves the result of the single collapsed node on the stack when one or more nodes in the graph have a true dependence on the single collapsed node.

15. A method as claimed in claim 1, wherein the set of patterns includes a set of collapse patterns and wherein a collapse pattern which creates a single collapsed node with a true dependence on one or more result-generating nodes in the graph is associated with a code generation rule which removes the results of the one or more result-generating nodes from the stack.

16. A method as claimed in claim 1 wherein the set of patterns includes a set of collapse patterns and wherein stack code is defined in step (iii) by traversing the graph and during traversal applying the following rule:
if the node is a collapsed node then schedule the constituent nodes according to the code generation rules associated with the pattern that matched the collapsed node.

17. A method as claimed in claim 1, wherein the stack code is JAVA bytecode or ECMA-335 instructions.

18. A system for generating optimised stack code from a register-based representation, including:
a processor arranged for creating a dependence graph from the representation; removing true dependencies from the dependence graph by matching portions of the dependence graph with a set of patterns; and defining stack code corresponding to the dependence graph using code generation rules associated with each pattern.

19. Software arranged for performing the method of claim 1.

20. Software arranged for performing the system of claim 18.

21. Storage media arranged for storing software as claimed in claim 19.

22. Storage media arranged for storing software as claimed in claim 20.
